(19) United States
(12) Patent Application Publication
(10) Pub. No.: US 2009/0110086 A1
(43) Pub. Date: Apr. 30, 2009

(54) Method and apparatus for performing bit loading in a multicarrier system

(76) Inventor: Alexandr V. KOZLOV, St. Petersburg (RU)

Correspondence Address: THE LAW OFFICES OF JOHN C. SCOTT, LLC;C/O INTELLEVELE, LLC, P. O. BOX 52050, MINNEAPOLIS, MN, 55402, US

(21) Appl. No.: 10/571,083

(22) PCT Filed: Jul. 1, 2005
(86) PCT No.: PCT/RU05/00366

§ 371 Date: Mar. 6, 2006

(51) Int. Cl. H04L 27/28

(52) U.S. Cl. 375/260

(57) ABSTRACT

Bit loading is performed in a multicarrier communication system in an efficient and computationally simple manner. In at least one embodiment, bit loading techniques are used that allow bit loading to be performed using fixed point computation. A bit loading cost function may be used that is calculated as the difference between two other functions. In one approach, the two other functions may be implemented as lookup tables. Bits may be allocated to subchannels having a lowest cost.

### TECHNICAL FIELD

The invention relates generally to multicarrier communications and, more particularly, to bit loading techniques for use in multicarrier systems.

### BACKGROUND OF THE INVENTION

Multicarrier communications is a communications technique where data is transmitted through a channel using a plurality of relatively narrowband subchannels. Each subchannel has a corresponding subcarrier that can be modulated with data to be transmitted through the subchannel. One type of multicarrier communication that is gaining in popularity is orthogonal frequency division multiplexing (OFDM). In an OFDM system, each subcarrier used in a channel is orthogonal to the other subcarriers of the channel. This orthogonality between subchannels decreases the crosstalk between subchannels in the system.

One problem that may arise in a wireless multicarrier system is multipath fading. In a wireless channel, signals may travel between a source node and a destination node by multiple different paths. These paths may include a direct path and one or more paths involving signal reflection from objects and structures in the wireless environment. The signals arriving at the receiver through the various paths will typically have different phases. Occasionally, the signals may combine out of phase at the receiver, resulting in a significant reduction in signal strength at the receiver. This reduction in signal strength is known as multipath fading. In many cases, multipath fading is a frequency selective effect that is more pronounced at some frequencies than at others. In a multicarrier system, this may result in some subchannels being inferior to others for use in transferring data. Bit loading is a technique that allows more bits to be transmitted within higher quality subchannels in a multicarrier channel and less bits (or no bits) to be transmitted within lower quality channels. Techniques are needed for efficiently allocating the bits to the various subchannels in a multicarrier system.

### BRIEF DESCRIPTION OF THE DRAWINGS

FIG. 1 is a diagram illustrating a wireless network arrangement that may be used within a multicarrier communication system in accordance with an embodiment of the present invention;

FIGS. 2 and 3 are portions of a flowchart illustrating an exemplary bit loading method for use in a multicarrier system in accordance with an embodiment of the present invention; and

FIG. 4 is a block diagram illustrating an exemplary architecture for use within a multicarrier device, component, or system in accordance with an embodiment of the present invention.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

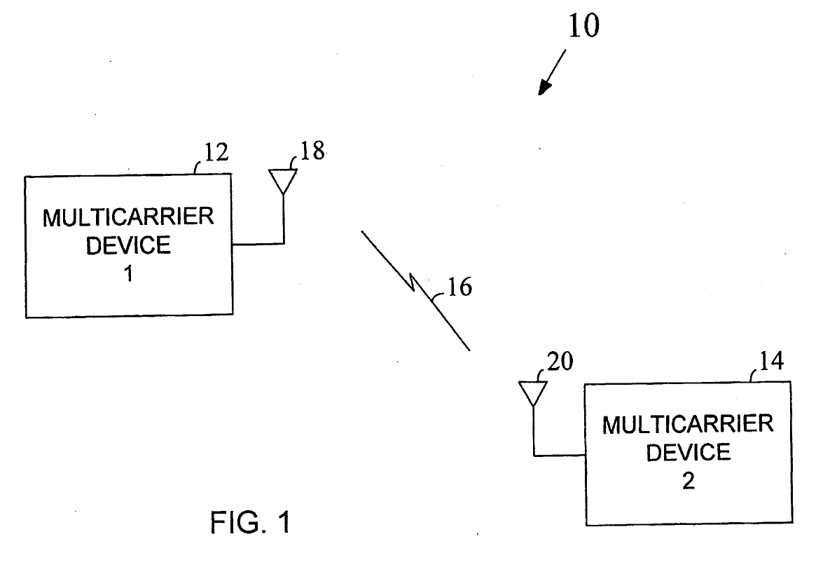

FIG. 1 is a diagram illustrating an exemplary wireless communication arrangement 10 that may be used within a multicarrier communication system in accordance with an embodiment of the present invention. As shown, the communication arrangement 10 includes a first multicarrier device 12 communicating with a second multicarrier device 14 through a wireless multicarrier channel 16. As shown, the first and second multicarrier devices 12, 14 may each include one or more antennas 18, 20 for use in transmitting and/or receiving wireless signals. Any type of antennas may be used including, for example, dipoles, patches, helical antennas, slot antennas, antenna arrays, and/or others. In systems implementing multiple input/multiple output (MIMO) techniques, each of the multicarrier devices 12, 14 will include multiple antennas. In some systems, the same antennas may be used by a device to perform both transmit and receive functions (i.e., antenna sharing may be implemented). In other systems, dedicated transmit and receive antennas may be used.

The signals transmitted between the multicarrier devices 12, 14 will typically include multicarrier symbols that each include a plurality of subcarriers. Each of the subcarriers within a multicarrier symbol may have data bits modulated thereon that are intended for delivery from one of the devices 12, 14 to the other. As described previously, some of the subchannels may be inferior to others because of certain channel effects, such as multipath fading. One technique to deal with non-uniformity between subchannels in a multicarrier channel is known as bit loading. Bit loading is a technique where a different number of bits may be allocated to different subchannels in a multicarrier channel, based on a perceived quality of the various subchannels. That is, better subchannels may be allocated a larger number of bits, while poorer quality subchannels are allocated a smaller number of bits (or no bits). The number of bits that are allocated to a particular subchannel will determine the type of modulation that is used to modulate a corresponding subcarrier. For example, if 2 bits are allocated to a particular subchannel, then quadrature phase shift keying (QPSK) may be used as a modulation technique for the corresponding subcarrier as it includes 2 bits per symbol. Similarly, if 4 bits are allocated to a subchannel, then 16 quadrature amplitude modulation (16 QAM) may be used as a modulation technique for the corresponding subcarrier as it includes 4 bits per symbol, and so on. One possible goal of bit loading may be to achieve, for example, an equal bit error rate for each of the subchannels of a multicarrier channel. It is desirable that bit loading techniques be capable of relatively quick operation to allow bit loading to be performed in real time within a high speed communication system. It is also desirable that bit loading techniques be developed that are of relatively low computational complexity to allow the techniques to be implemented within hardware that is less sophisticated (e.g., processors that use fixed point computation rather then floating point computation). In at least one aspect of the present invention, techniques and structures are provided for performing bit loading in a low complexity manner.

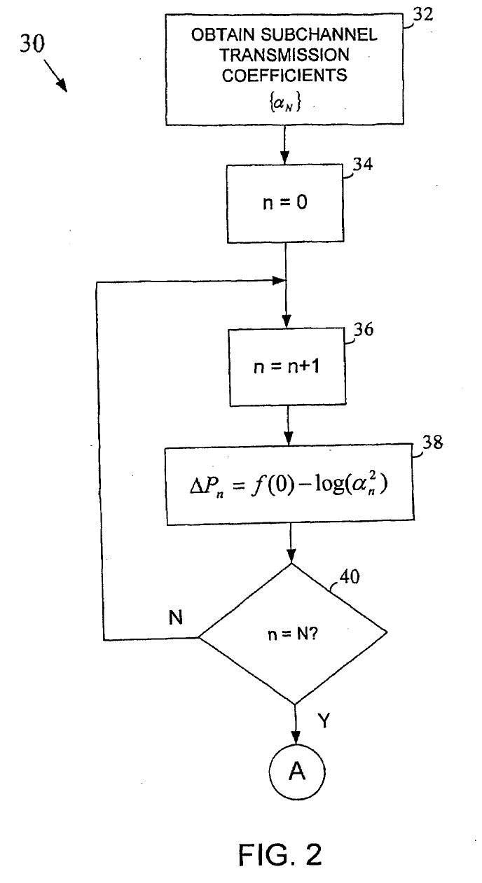

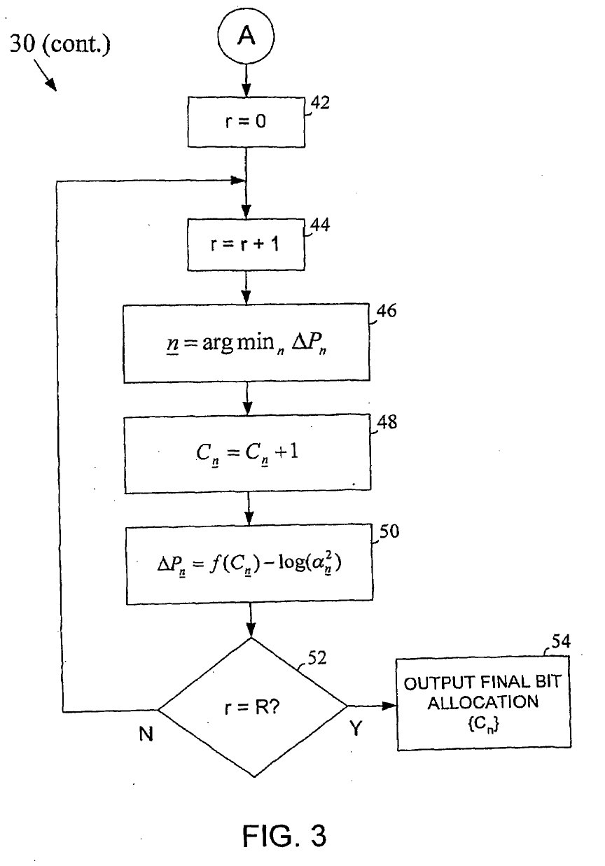

FIGS. 2 and 3 are portions of a flowchart illustrating an exemplary bit loading method 30 for use in a multicarrier system in accordance with an embodiment of the present invention. The method 30 may be practiced within, for example, the wireless communication arrangement 10 of FIG. 1 or within other multicarrier networks and systems. As shown in FIG. 2, subchannel transmission coefficients αₙ are first obtained for the subchannels of the multicarrier channel (block 32). In at least embodiment, the transmission coefficients are estimated within the communication device implementing the method 30 using, for example, training symbols received by the device through the multicarrier channel. In some other embodiments, transmission coefficients may be received directly from a remote device or system through the multicarrier channel. In one approach, transmission coefficients are obtained for each of the subchannels within the multicarrier channel. In another approach, coefficients are only obtained for some of the subchannels. In such a case, coefficients for the other subchannels may be developed using, for example, interpolation and/or similar techniques.

A subchannel index n may next be initialized to zero or some other starting value (block 34). The subchannel index may then be incremented by 1 to indicate the first subchannel (block 36). A cost function ΔPₙ is then evaluated for the first subchannel to develop an initial cost value therefor (block 38). The cost function may be expressed as:

ΔPₙ=ƒ(Cₙ)−log(αₙ²)

where Cₙ is a number of bits currently allocated to subchannel n, ƒ(Cₙ) is a cost function that returns a baseline cost value for adding an additional bit to subchannel n, and log(αhd n²) is the logarithm of the square of the transmission coefficient for subchannel n. For the initial cost values, it is assumed that no bits have yet been allocated to any of the subchannels. Therefore, the above expression becomes:

ΔPₙ=ƒ(0)−log(αₙ²).

After the initial cost value has been determined for the first subchannel, it is next determined whether index n is equal to N, which is the total number of subchannels in the multicarrier channel (block 40). If n is not equal to N, the method 30 returns to block 36 and the index n is again incremented. This process then repeats until initial cost values have been determined for each of the subchannels (block 40-Y). These initial values may be stored within a storage device.

Referring now to FIG. 3, after the initial cost values have been determined, the allotment of bits to the various subchannels may commence. An iteration index r is first initialized to zero or some other starting value (block 42). The index r is then incremented by one to indicate the first iteration (block 44). Using the initial cost values calculated above, a subchannel n is next identified that has a best (i.e., lowest) cost value (block 46). This low cost value is indicative of a higher subchannel quality. The number of bits currently allocated to subchannel n (i.e., Cₙ) is then incremented by 1 (block 48). The cost value associated with identified subchannel n may then be updated as follows:

ΔPₙ=ƒ(Cₙ)−log(αₙ²)

using the new value of Cₙ (block 50).

It is next determined whether the index r is equal to R, the number of bits to be included within a multicarrier symbol (block 52). As r is still 1 at this point, the equality is false and the method 30 returns to block 44 where the index r is again incremented by 1. A new subchannel n is now identified that has a lowest cost value (block 46). This time, however, the updated cost value ΔPₙ of previous subchannel n is used during the determination of block 46, rather than the initial cost value. The new subchannel n may be the same as or different from the previous subchannel n. The number of bits currently allocated to new subchannel n is then incremented by 1 (block 48) and the associated cost value is incremented (block 50). The above described process is then repeated until the index r reaches the number of bits R to be allocated (block 52-Y). At this time, the final bit allocation may be output (block 54).

In at least one embodiment of the present invention, lookup tables are utilized to store the values of one or both of the functions ƒ(Cₙ) and log(αₙ²). The lookup tables allow a function value to be quickly retrieved using a corresponding input value. Thus, to retrieve a value for ƒ(2), for example, a value of 2 may be input to the corresponding lookup table which may then output the value of ƒ(2). Similarly, to retrieve a value of log(α₃²), the value of α₃ may be input to the corresponding lookup table which may then output the value of the logarithm. To implement this approach for the log(αₙ²) function, the values of αₙ that are used may be quantized to a predetermined number of digital values for input to the corresponding lookup table. Once values for ƒ(Cₙ) and log(αₙ²) have been retrieved from the corresponding lookup tables, the second value may simply be subtracted from the first, using fixed point computation, to achieve the desired cost value for a subchannel. The lookup tables may be implemented using any method including, for example, as a semicondiuctor memory (e.g., RAM, ROM, etc.) on a chip, using sequential logic, etc.

The method 30 of FIGS. 2 and 3 will typically be performed repeatedly during the operation of a multicarrier device, system, or component. The frequency of the repetition may be implementation specific. For example, one system may repeat the method for every multicarrier symbol transmitted, another may repeat the method once for every packet transmitted, where a packet may include many multicarrier symbols (e.g., 100 OFDM symbols), and so on. In channels where subchannel coefficients do not change appreciable, such as wired digital subscriber line (DSL) channels, the method 30 may be performed only once during each communication session (e.g., at the establishment of a connection).

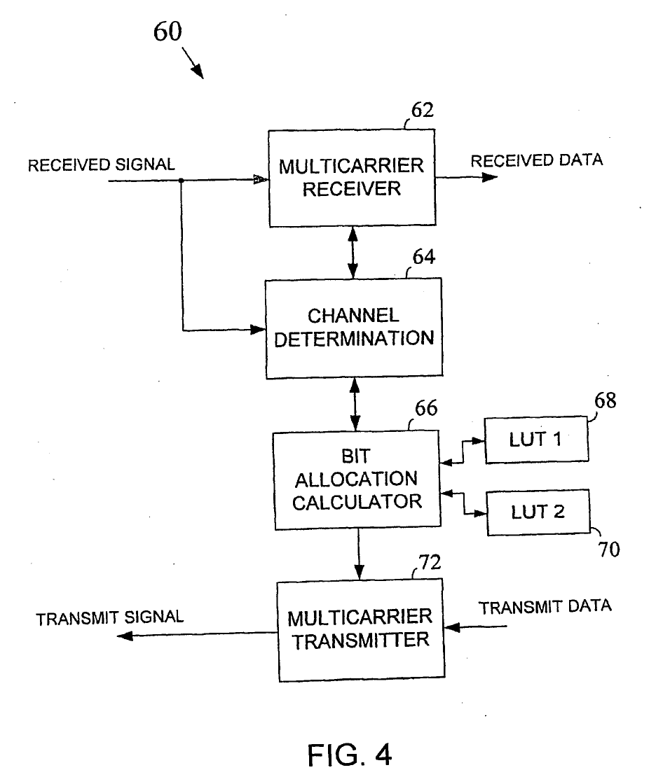

FIG. 4 is a block diagram illustrating an exemplary architecture 60 for use within a multicarrier device, component, or system in accordance with an embodiment of the present invention. As illustrated, the architecture 60 may include: a multicarrier receiver 62, a channel determination unit 64, a bit allocation calculator 66, a first lookup table (LUT 1) 68, a second lookup table (LUT 2) 70, and a multicarrier transmitter 72. The multicarrier receiver 62 is operative for processing a multicarrier signal received from a remote communication entity to recover user data encoded therein. The channel determination unit 64 is operative for acquiring channel information for the multicarrier channel. The channel information may include, for example, transmission coefficients αₙ for the subchannels of the multicarrier channel. The bit allocation calculator 66 is operative for allocating bits to the subchannels of the multicarrier channel. The first and second LUTs 68, 70 are used to store function values for use by the bit allocation calculator 66 to appropriately allocate the bits. The multicarrier transmitter 72 is operative for generating a multicarrier transmit signal for transmission to the remote communication entity. The multicarrier transmitter 72 may receive bit allocation information developed by the bit allocation calculator 66 and use the information to allocate input transmit data bits to the subcarriers of the multicarrier signal to be transmitted. That is, the multicarrier transmitter 72 may utilize a modulation technique for each subcarrier of the transmit signal that is in accordance with the number of bits allocated to the corresponding subchannel.

In at least one embodiment, the channel determination unit 64 is a channel estimator that estimates the channel information using training symbols received from a remote communication entity through the multicarrier channel. Such channel estimation techniques are well known in the art. In other embodiments, the channel determination unit 64 may be a unit that simply receives channel information from a remote communication entity and stores the information for later use. For example, a multicarrier device that includes the architecture 60 of FIG. 4 may transmit training symbols to a remote communication entity which uses the training symbols to develop channel information. The remote communication entity may then transmit the channel information back to the multicarrier device, where it is stored by the channel determination unit 64.

The channel determination unit 64 may make the acquired channel information available to the multicarrier receiver 62 for use in processing received signals. The channel determination unit 64 may also make the channel information available to the bit allocation calculator 66 for use in allocating bits to the subchannels of the multicarrier channel. In at least one embodiment, the bit allocation calculator 66 may be adapted to perform the bit allocation method 30 of FIGS. 2 and 3, or a variant thereof. For example, the bit allocation calculator 66 may first determine initial cost values for each of the subchannels using the cost function ΔPₙ=ƒ(0)−log(αₙ²). The value of ƒ(0) may be retrieved from the first LUT 68 and used for all subchannels. The value of log(αₙ²) may be retrieved from the second LUT 70 for each specific subchannel, based on the corresponding transmission coefficient. The bit allocation calculator 66 may then perform a simple subtraction operation to generate the initial cost value for each subchannel. After the initial cost values have been developed, the bit allocation calculator 66 may perform R allocation iterations to allocate R bits to the subchannels of a multicarrier transmit signal. In each iteration, the bit allocation calculator 66 may identify a subchannel n having a best (e.g., lowest) cost value and allocate an additional bit to that subchannel. The bit allocation calculator 66 may then update the cost value for the identified subchannel n.

In at least one embodiment, the bit allocation calculator 66 uses the cost function ΔPₙ=ƒ(Cₙ)−log(αₙ²) to perform the update. The bit allocation calculator 66 may retrieve the value of ƒ(Cₙ) from the first LUT 68 and the value of log(αₙ²) from the second LUT 70. The bit allocation calculator 66 may then perform a simple subtraction operation to generate the updated cost value for the identified subchannel. In this manner, the bit allocation calculator 66 may be implemented using a processor that is only capable of fixed point computation and not the more complex floating point computation. It should be appreciated that the architecture 60 of FIG. 4 represents one possible architecture that may be used to implement the invention. Other architectures may alternatively be used.

In at least one embodiment of the invention, the values that are stored within the first LUT 68 are developed using a numerical optimization algorithm. This may include, for example, linear optimization techniques, genetic optimization algorithms, and/or others. In at least one approach, the optimization technique will include a criterion where a resulting bit error rate depends on the modulation, coding, and equalization scheme used. By appropriately selecting the values to be stored in the first LUT 68, the bit allocation calculator 66 can be made to emulate a bit allocation technique having a much higher computation complexity, such as the well known KRJ algorithm. In at least one implementation, the techniques of the present invention have been shown to be capable of emulating the KRJ algorithm relatively accurately at a complexity level that is from 10 to 100 times lower.

In the embodiments described above, the same values of ƒ(Cₙ) were used for all of the different subchannels of a multicarrier channel. In other embodiments, however, different values may be used for different subchannels. For example, different LUTs may be used to store ƒ(Cₙ) values for different subchannels or subchannel groups. This may be the case when, for example, a priori information is available about some subchannels that allows different ƒ(Cₙ) values to be developed for those subchannels.

In the embodiments described above, bit loading is the only technique that is used to mitigate the effects of non-uniformity in the multicarrier channel (caused by, for example, multipath fading, etc.). In other embodiments, other techniques may be utilized in addition to bit loading such as, for example, power allocation. However, addition of these techniques may require slight adjustment to the bit loading procedures described above (e.g., slight changes to the Cₙ=Cₙ+1 block in FIG. 3, etc.).

As described above, one type of multicarrier communication that is currently popular is OFDM. Thus, in various embodiments, features of the invention may be implemented in OFDM based communication systems. The inventive techniques may be used in both wired and wireless multicarrier systems. For example, in at least one embodiment, features of the invention are used within a wired DSL system. Aspects of the invention may be implemented in a wide variety of different wireless communication links including, for example, wireless network links (LANs, MANs, WANs, etc.), terrestrial wireless links, wireless satellite links, wireless cellular links, links within a wireless distribution system (e.g., local multipoint distribution service (LMDS), multichannel multipoint distribution service (MMDS), etc.), and/or others.

The techniques and structures of the present invention may be implemented in any of a variety of different forms. For example, features of the invention may be embodied within cellular telephones and other handheld wireless communicators; personal digital assistants having wireless capability; laptop, palmtop, desktop, and tablet computers having wireless capability; pagers; satellite communicators; network access points, cellular base stations, network interface cards (NICs) and other network interface structures; integrated circuits; as instructions and/or data structures stored on machine readable media; and/or in other formats. Examples of different types of machine readable media that may be used include floppy diskettes, hard disks, optical disks, compact disc read only memories (CD-ROMs), magneto-optical disks, read only memories (ROMs), random access memories (RAMs), erasable programmable ROMs (EPROMs), electrically erasable programmable ROMs (EEPROMs), magnetic or optical cards, flash memory, and/or other types of media suitable for storing electronic instructions or data. In at least one form, the invention is embodied as a set of instructions that are modulated onto a carrier wave for transmission over a transmission medium.

It should be appreciated that the individual blocks illustrated in the block diagrams herein may be functional in nature and do not necessarily correspond to discrete hardware elements. For example, in at least one embodiment, two or more of the blocks in a diagram may be implemented in software within a single digital processing device. The digital processing device may include, for example, a general purpose microprocessor, a digital signal processor (DSP), a reduced instruction set computer (RISC), a complex instruction set computer (CISC), a field programmable gate array (FPGA), an application specific integrated circuit (ASIC), and/or others. Hardware, software, firmware, and hybrid implementations may be used.

In the foregoing detailed description, various features of the invention are grouped together in one or more individual embodiments for the purpose of streamlining the disclosure. This method of disclosure is not to be interpreted as reflecting an intention that the claimed invention requires more features than are expressly recited in each claim. Rather, as the following claims reflect, inventive aspects may lie in less than all features of each disclosed embodiment.

Although the present invention has been described in conjunction with certain embodiments, it is to be understood that modifications and variations may be resorted to without departing from the spirit and scope of the invention as those skilled in the art readily understand. Such modifications and variations are considered to be within the purview and scope of the invention and the appended claims.

What is claimed is:

1. A method for performing bit loading in a multicarrier communication system, comprising:
obtaining transmission coefficients αₙ for subchannels of a multicarrier channel, where n is a subchannel index;
calculating initial cost values for said subchannels using said transmission coefficients;
identifying a subchannel n having a lowest cost value;
allocating a new bit to said identified subchannel n; and
updating said cost value of said identified subchannel n, after allocating a new bit, using a cost function:
ΔPₙ=ƒ(Cₙ)−g(αₙ)
where Cₙ is a number of bits allocated to a subchannel n, ƒ(Cₙ) is a function of Cₙ that returns a baseline cost value for allocating an additional bit to subchannel n, and g(αₙ) is a function of transmission coefficient αₙ.

2. The method of claim 1, further comprising:
repeating identifying, allocating, and updating for a total of R iterations, where R is a number of bits to be allocated.

3. The method of claim 1, wherein:
said function g(αₙ) is equal to log(αₙ²), which is the logarithm of the square of the channel coefficient of subchannel n.

4. The method of claim 1, wherein:
updating said cost value includes retrieving a value for ƒ(Cₙ) from a first lookup table.

5. The method of claim 1, wherein:
updating said cost value includes retrieving a value for g(αₙ) from a second lookup table.

6. The method of claim 1, wherein:
calculating initial cost values includes evaluating the cost function:
αPₙ=ƒ(0)−log(αₙ²)
for each subchannel, where ƒ(0) is a baseline cost value assuming no allocated bits for a subchannel n and log(αₙ²) is the logarithm of the square of the channel coefficient of subchannel n.

7. The method of claim 6, wherein:
calculating initial cost values includes retrieving a value for ƒ(0) from a first lookup table.

8. The method of claim 6, wherein:
calculating initial cost values includes retrieving values for log(αₙ²) from a second lookup table for subchannels of said multicarrier channel.

9. The method of claim 1, wherein:
obtaining transmission coefficients includes acquiring said transmission coefficients from a local channel estimator.

10. The method of claim 1, wherein:
obtaining transmission coefficients includes receiving said transmission coefficients from a remote communication entity.

11. An apparatus comprising:
a channel determination unit to obtain transmission coefficients αₙ for subchannels of a multicarrier channel;
a bit allocation calculator to determine bit allocations for said subchannels of said multicarrier channel using said transmission coefficients, said bit allocation calculator to calculate cost values for said subchannels as a difference between a first function and a second function;
a first lookup table to store and retrieve values of said first function for use by said bit allocation calculator; and
a second lookup table to store and retrieve values of said second function for use by said bit allocation calculator.

12. The apparatus of claim 11, wherein:
said first function is a function that returns a threshold cost of allocating an additional bit to a subchannel based on a presently allocated number of bits.

13. The apparatus of claim 11, wherein:
said second function is a function that returns a logarithm of a square of a transmission coefficient for a corresponding subchannel.

14. The apparatus of claim 11, wherein:
said channel determination unit is a channel estimator to estimate said transmission coefficients using training signals received via said multicarrier channel.

15. The apparatus of claim 11, wherein:
said bit allocation calculator is operative to: calculate initial cost values for said subchannels of said multicarrier channel assuming zero bits allocated to each subchannel, identify a subchannel with a lowest cost value, allocate an additional bit to said identified subchannel, and update a cost value of said identified subchannel using information from said first and second lookup tables.

16. The apparatus of claim 15, wherein:
said bit allocation calculator is operative to: identify a subchannel with a lowest cost value, allocate an additional bit to said identified subchannel, and update a cost value of said identified subchannel using information from said first and second lookup tables for each bit to be included within a multicarrier symbol.

17. The apparatus of claim 11, wherein:
said multicarrier channel is an orthogonal frequency division multiplexing (OFDM) channel.
